(19) United States
(12) Patent Application Publication
(10) Pub. No.: US 2008/0095548 A1
(43) Pub. Date: Apr. 24, 2008

(54) Flash fixing apparatus, image formation device, and image formation method

(75) Inventors: Akira Iwaishi, Kanagawa (JP); Kunihiko Sato, Kanagawa (JP); Hiroshi Nou, Kanagawa (JP); Mitsuhiro Mori, Kanagawa (JP); Yoshikazu Yamamoto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/785,332

(22) Filed: Apr. 17, 2007

(30) Foreign Application Priority Data
Oct. 24, 2006 (JP) 2006-288471

(51) Int. Cl. G03G 15/00; G03G 15/20

(52) U.S. Cl. 399/45; 399/67; 399/336

(57) ABSTRACT

A flash fixing apparatus including a plurality of lamp groups each comprising at least one lamp, and an emission controller. The lamp groups illuminate flashes at a recording medium to fix a toner image which has been transferred to the recording medium. The emission controller causes the respective lamp groups to emit light with different emission timings, and alters the emission timings in accordance with the toner of the toner image and physical characteristics of the recording medium.

### CROSS-REFERENCE TO RELATED APPLICATIONS

This application is based on and claims priority under 35 USC 119 from Japanese Patent Application No. 2006-288471 filed Oct. 24, 2006.

### BACKGROUND

1. Technical Field

The present invention relates to a flash fixing apparatus, an image formation device, and an image formation method.

2. Related Art

As image formation devices, printers which form toner images by a dry electrophotography system or the like are known. In such a printer, in order to form an image with powder toner on a recording medium, the powder toner on the recording medium is fused and the toner image is fixed to the recording medium.

To fix the toner image, it is necessary to provide fixing energy to the recording medium. As a method for providing this fixing energy, a non-contact-type flash fixing apparatus which utilizes a flash from a xenon lamp has been known. A non-contact-type fixing method can apply high levels of energy without affecting conveyance of the recording medium.

### SUMMARY

In consideration of the above circumstances, the present invention provides a flash fixing apparatus, an image formation device, and an image formation method.

According to an aspect of the invention, there is provided a flash fixing apparatus comprising: plural lamp groups each comprising at least one lamp, the each lamp group illuminating a flash at a recording medium to fix a toner image which has been transferred to the recording medium; and an emission controller that causes the lamp groups to emit light with different emission timings, and that alters the emission timings in accordance with a toner of the toner image and a physical characteristic of the recording medium.

### BRIEF DESCRIPTION OF THE DRAWINGS

Exemplary embodiments of the present invention will be described in detail based on the following figures, wherein:

FIG. 1 is a schematic view showing overall structure of an image formation device relating to a first exemplary embodiment of the present invention;

FIG. 2A is a schematic view of a flash fixing apparatus relating to the first exemplary embodiment, FIG. 2B shows timing charts illustrating flash timings of first, second and third xenon lamp groups, and FIG. 2C is a notional view showing a pattern of distribution of energy supplied to a recording medium;

FIG. 3 is a schematic structural view showing a driving circuit of the flash fixing apparatus relating to the first exemplary embodiment;

FIG. 4 is a graph showing a surface temperature of transforming toner and a boundary surface temperature of a recording medium in a case in which flash illumination by the flash fixing apparatus relating to the first exemplary embodiment is divided into three flashes;

FIGS. 5A to 5E are conceptual views of state-transformation of toner in the case in which flash illumination by the flash fixing apparatus relating to the first exemplary embodiment is divided into three flashes;

FIG. 6 is a graph showing relationships between toner surface temperature and recording medium boundary surface temperature, which rise due to flash illumination from the flash fixing apparatus relating to the first exemplary embodiment, and density/thermal conductivity of the recording medium;

FIG. 7 is a graph showing relationships between toner surface temperature and recording medium boundary surface temperature, which rise due to flash illumination from the flash fixing apparatus relating to the first exemplary embodiment, and medium thickness of the recording medium;

FIG. 8 is a graph showing relationships between toner surface temperature and recording medium boundary surface temperature, which rise due to flash illumination from the flash fixing apparatus relating to the first exemplary embodiment, and medium temperature of the recording medium;

FIG. 9 is a graph showing transforming toner surface temperature and recording medium boundary surface temperature in a case in which flash illumination by the flash fixing apparatus relating to the first exemplary embodiment is applied to, for example, a low-density recording medium P;

FIGS. 10A to 10E are conceptual views of state-transforming toner in the case in which flash illumination by the flash fixing apparatus relating to the first exemplary embodiment is applied to, for example, the low-density recording medium P;

FIG. 11 is a graph showing transforming toner surface temperature and recording medium boundary surface temperature in a case in which flash illumination by the flash fixing apparatus relating to the first exemplary embodiment is applied to, for example, a high-density recording medium P;

FIGS. 12A to 12D are conceptual views of state-transforming toner in the case in which flash illumination by the flash fixing apparatus relating to the first exemplary embodiment is applied to, for example, the high-density recording medium P;

FIG. 13 is a graph showing toner surface temperature and recording medium boundary surface temperature when, in a case in which flash illumination by the flash fixing apparatus relating to the first exemplary embodiment is applied to, for example, the low-density recording medium P, and an emission timing of a xenon lamp group is delayed;

FIG. 14 is a graph showing toner surface temperature and recording medium boundary surface temperature when, in a case in which flash illumination by the flash fixing apparatus relating to the first exemplary embodiment is applied to, for example, the low-density recording medium P, the emission timing of the xenon lamp group is delayed and a voltage supplied to the xenon lamp group is altered;

FIG. 15 is a graph showing toner surface temperature and recording medium boundary surface temperature when, in a case in which flash illumination by the flash fixing apparatus relating to the first exemplary embodiment is applied to, for example, the high-density recording medium P, and the emission timing of a xenon lamp group is advanced;

FIG. 16 is a diagram showing a table which shows delay durations of emission timings of xenon lamp groups in accordance with medium temperatures of recording mediums, for the xenon lamp groups relating to the first exemplary embodiment;

FIG. 17 is a chart showing a flow of control, illustrating a control sequence for altering the emission timing of a xenon lamp group in accordance with a medium temperature of a recording medium, for the xenon lamp groups relating to the present exemplary embodiment;

FIG. 18 is a graph showing a function for altering the emission timings of the xenon lamp groups relating to the present exemplary embodiment.

FIG. 19 is a table which shows delay durations of emission timings of the xenon lamp groups in accordance with recording medium types, for the xenon lamp groups relating to the present exemplary embodiment;

FIG. 20 is a table which shows delay durations of emission timings of the xenon lamp groups and FV voltages to be supplied to the xenon lamp groups in accordance with recording medium types, for the xenon lamp groups relating to the present exemplary embodiment;

FIG. 21 is a table which shows delay durations of emission timings of the xenon lamp groups and FV voltages to be supplied to the xenon lamp groups in accordance with recording medium types, for the xenon lamp groups relating to the present exemplary embodiment, showing a case in which the FV voltages are altered for each of the xenon lamp groups;

FIG. 22 is a schematic view showing a flash fixing apparatus relating to a second exemplary embodiment;

FIG. 23 is a graph showing conditions of toner temperature when a first xenon lamp group and a second xenon lamp group relating to the second exemplary embodiment are caused to emit light simultaneously;

FIG. 24 shows conditions of toner temperature when the emission timings of the first xenon lamp group and second xenon lamp group relating to the second exemplary embodiment are offset;

FIG. 25 shows conditions of toner temperature in a case in which the emission timings of the first xenon lamp group and second xenon lamp group relating to the second exemplary embodiment are offset, and the flashes are illuminated at colored paper at a recording medium P;

FIG. 26 shows conditions of toner temperature when, in the case in which the emission timings of the first xenon lamp group and second xenon lamp group relating to the second exemplary embodiment are offset and the flashes are illuminated at colored paper at a recording medium P, an emission timing is delayed;

FIG. 27 shows conditions of toner temperature in a case in which the emission timings of the first xenon lamp group and second xenon lamp group relating to the second exemplary embodiment are offset, and the flashes are illuminated at color toner with low thermal absorptivity;

FIG. 28 shows conditions of toner temperature when, in the case in which the emission timings of the first xenon lamp group and second xenon lamp group relating to the second exemplary embodiment are offset and the flashes are illuminated at color toner with low thermal absorptivity, an emission timing is advanced;

FIG. 29A is a chart showing levels of time differences between emission timings of the first xenon lamp group and second xenon lamp group relating to the second exemplary embodiment, FIG. 29B is a chart showing the levels that are applied to black-and-white images and color images, and FIG. 29C is a chart showing the levels that are applied in accordance with thicknesses of paper; and

FIG. 30A is a chart showing the levels that are applied in accordance with colors of paper, FIG. 30B is a chart showing level values being modified in accordance with color densities, and FIG. 30C is a chart showing the levels that are applied in accordance with temperatures of paper.

### DETAILED DESCRIPTION

Herebelow, an example of an exemplary embodiment relating to the present invention will be described on the basis of the drawings.

### First Exemplary Embodiment

### —Overall Structure of Image Formation Device Relating to First Exemplary Embodiment—

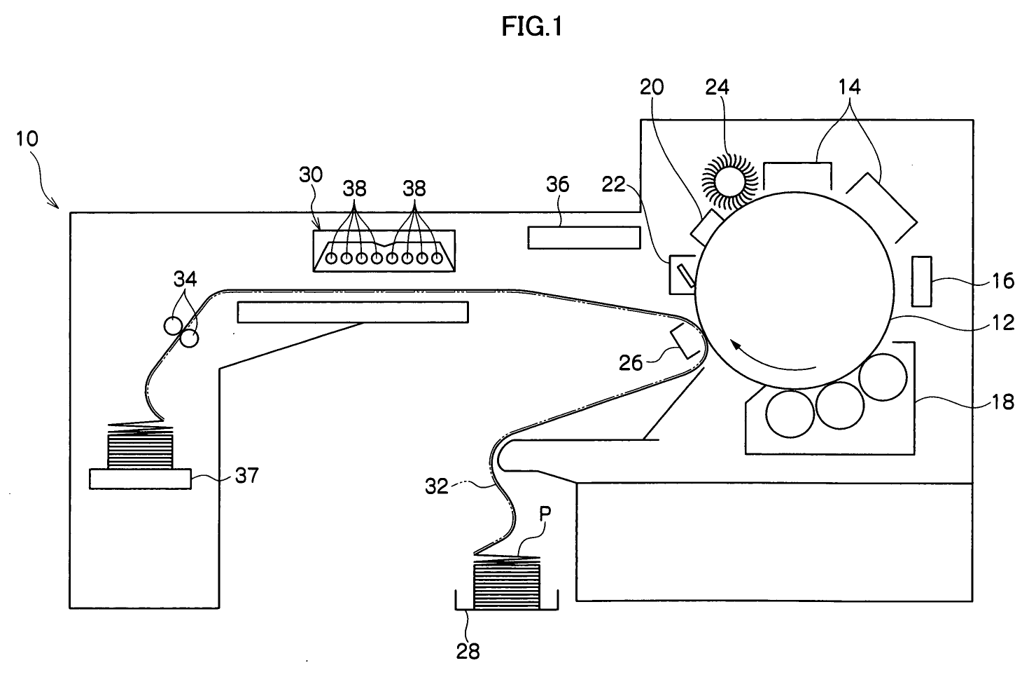

Firstly, overall structure of an image formation device relating to the first exemplary embodiment will be described. FIG. 1 shows overall structure of the image formation device relating to the first exemplary embodiment.

An image formation device 10 relating to the first exemplary embodiment is provided with a recording medium accommodation portion 28 which accommodates a recording medium P, as shown in FIG. 1. In the first exemplary embodiment, as the recording medium P, continuous paper formed as a long belt is employed. This continuous paper is paper which is cut to a predetermined size after images are formed. The recording medium P could also be, for example, paper which is formed to a predetermined size beforehand, “cut paper”, but may be any recording medium at which an image is to be formed.

The recording medium P is folded up and accommodated in the recording medium accommodation portion 28, and the accommodated recording medium P is conveyed by a conveyance apparatus 34 along a conveyance path 32 formed inside the image formation device 10.

In the first exemplary embodiment, a pair of conveyance rollers which nips the recording medium P and rotates is employed as the conveyance apparatus 34. The conveyance apparatus 34 may be a conveyance apparatus which causes pins to engage with plural transport holes formed along longitudinal directions at each of two width direction end portions of the recording medium P, which are side edge portions, and conveys the recording medium P, but could be any conveyance apparatus which conveys the recording medium P.

A photoreceptor drum 12, which rotates in a predetermined direction, and a flash fixing apparatus 30 are provided along the conveyance path 32 along which the recording medium P is conveyed, in that order from a conveyance direction upstream side. The flash fixing apparatus 30 provided with xenon lamps 38 is an example of a flash fixing apparatus provided with xenon lamps. In the present exemplary embodiment, the photoreceptor drum 12 rotates in the clockwise direction of FIG. 1.

Around the photoreceptor drum 12, in this order from the rotation direction upstream side of the photoreceptor drum 12, a charging apparatus 14, an exposure apparatus 16, a developing apparatus 18, a cleaner plate 22, a charge removal apparatus 20 and a cleaner brush 24 are provided. The charging apparatus 14 charges up a surface of the photoreceptor drum 12. The exposure apparatus 16 exposes the charged photoreceptor drum 12 to form an electrostatic latent image at the surface of the photoreceptor drum 12. The developing apparatus 18 develops the electrostatic latent image that has been formed at the surface of the photoreceptor drum 12 to form a toner image. The cleaner plate 22 cleans off residual toner remaining on the photoreceptor drum 12. The charge removal apparatus 20 eliminates charge from the surface of the photoreceptor drum 12. The cleaner brush 24 cleans off residual toner remaining on the photoreceptor drum 12.

Further, at a position opposing the photoreceptor drum 12, a transfer apparatus 26 is provided which nips the conveyance path 32 against the photoreceptor drum 12 and transfers the toner image that has been formed on the photoreceptor drum 12 onto the recording medium P.

The flash fixing apparatus 30 causes the xenon lamps 38, which are the flash lamp, to emit light, and thus irradiates a flash at the recording medium P and fixes the toner image which has been transferred onto the recording medium P. The recording medium P to which the toner image has been fixed by the flash fixing apparatus 30 is conveyed further to a downstream side, and is folded up and accommodated at a recording medium accommodation section 37 for accommodating the recording medium P.

### —Structure of the Flash Fixing Apparatus 30 Relating to the First Exemplary Embodiment—

Next, structure of the flash fixing apparatus 30 relating to the first exemplary embodiment will be described.

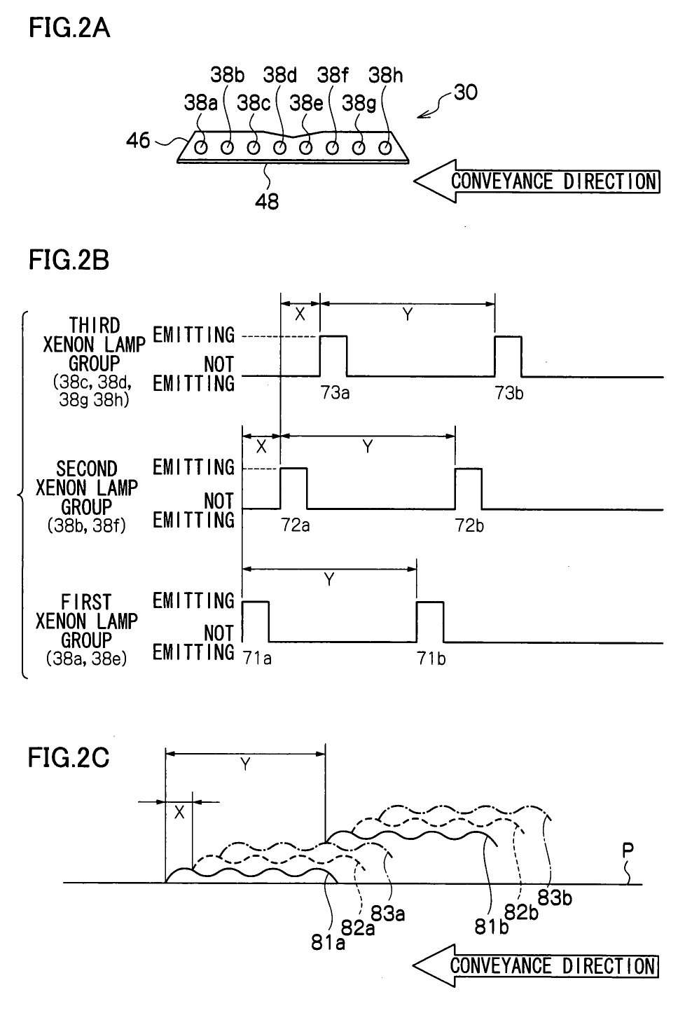

As shown in FIG. 2A, the flash fixing apparatus 30 relating to the first exemplary embodiment is provided with plural xenon lamps 38. In the first exemplary embodiment, eight of the xenon lamps 38 are employed.

Each xenon lamp 38 is oriented such that a length direction thereof, which is to say an axial direction thereof, is along a width direction of the recording medium P, which is to say a direction intersecting the conveyance direction of the recording medium P, and the xenon lamps 38 are arranged with a constant spacing along the conveyance direction of the recording medium P.

At a rear face side of the xenon lamps 38 as viewed from the conveyance path 32 side of the recording medium P, a reflection plate 46 is provided. The reflection plate 46 has a form which encloses the rear face side of the eight xenon lamps 38 and is formed with an opening at the front face side, that is, the conveyance path 32 side of the xenon lamps 38. The reflection plate 46 reflects flash light that is illuminated to the rear face side from the xenon lamps 38 toward the conveyance path 32.

A cover glass 48 is disposed at the front face side of the xenon lamps 38, that is, the conveyance path 32 side thereof. The cover glass 48 is provided so as to close off the opening of the reflection plate 46.

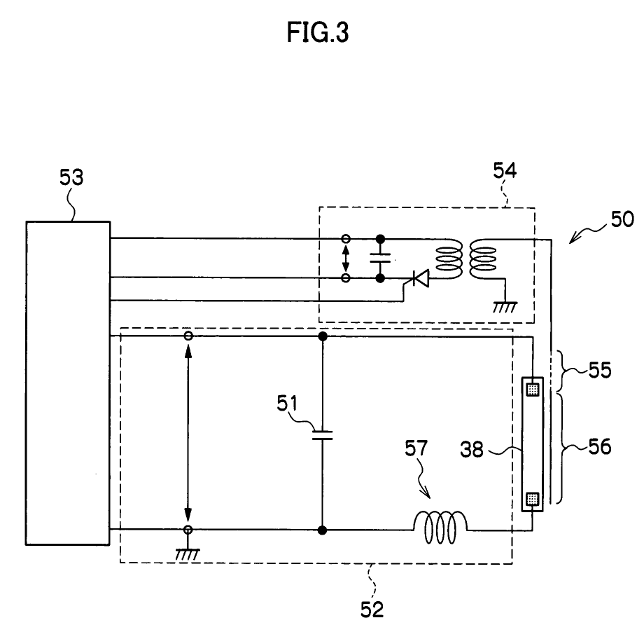

As shown in FIG. 3, a driving circuit 50 is connected to each xenon lamp 38. The driving circuit 50 is provided with a power supply circuit 52 which is connected to each of two end portions of the respective xenon lamp 38.

In this driving circuit 50, a capacitor 51 in the power supply circuit 52 is charged up by a flash control power supply 53, and a voltage is applied to a trigger wire 56 by a trigger circuit 54, which is controlled by the flash control power supply 53, via a trigger cable 55. Accordingly, Xe gas inside the xenon lamp 38 is excitated and emits light.

The power supply circuit 52 also includes a choke coil 57. A current flowing into the xenon lamp 38 is altered by adjustment of the magnitude of an impedance of this choke coil 57. Thus, a gradient of change of light amount and a light amount peak of the flash from the xenon lamp 38, and a duration for which light is emitted, are altered. For example, if the choke coil 57 is made larger, the gradient of change of light amount of the flash becomes larger, a current becomes larger since the current flows in one burst, and the energy emitted as light increases.

A controller 36, which serves as a light emitting controller for controlling the driving circuit 50, is connected to the driving circuit 50 (see FIG. 1). By the controller 36 controlling the driving circuit 50, voltages supplied to the xenon lamps 38 and timings of light emissions from the xenon lamps 38 are controlled.

In the first exemplary embodiment, of the eight xenon lamps 38a to 38h shown in FIG. 2A, the xenon lamps 38a and 38e serve as a first xenon lamp group, the xenon lamps 38b and 38f serve as a second xenon lamp group, and the xenon lamps 38c, 38d, 38g and 38h serve as a third xenon lamp group.

Thus, the xenon lamps 38a to 38h are divided into two xenon lamp groups constituted of two lamps and one xenon lamp group constituted of four lamps, and each xenon lamp group is caused to emit light in turn.

As shown in FIG. 2B, the controller 36 controls such that the flash control power supplies 53 connected to the respective xenon lamps 38a to 38h send signals to the trigger circuits 54 such that: the first xenon lamp group emits light for a predetermined period with a predetermined emission interval Y; the second xenon lamp group emits light for a predetermined period with the predetermined emission interval Y, with timings delayed relative to the emission timings of the first xenon lamp group by a predetermined delay X; and the third xenon lamp group emits light for a predetermined period with the predetermined emission interval Y, with timings delayed relative to the emission timings of the second xenon lamp group by the predetermined delay X.

Here, trigger timings 71a and 71b at which the first xenon lamp group emits light, trigger timings 72a and 72b at which the second xenon lamp group emits light and trigger timings 73a and 73b at which the third xenon lamp group emits light, which are shown in FIG. 2B, correspond, respectively, to curves 81a and 81b, curves 82a and 82b and curves 83a and 83b, which are shown in FIG. 2C.

Next, for a case in which flash illuminations by the xenon lamps 38 are divided into three flashes as described above, changes in toner surface temperature and recording medium boundary surface temperature and a toner state transformation will be described.

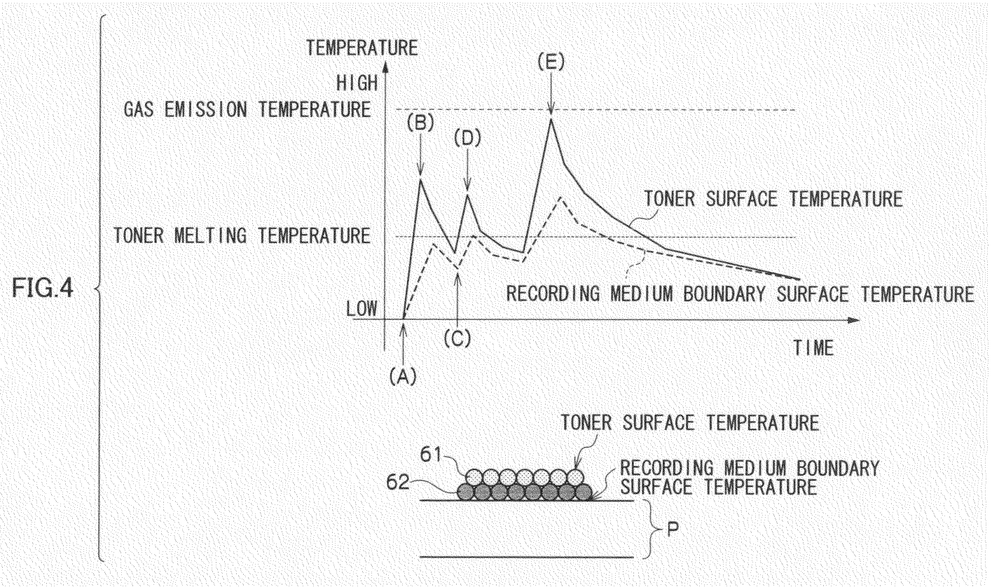

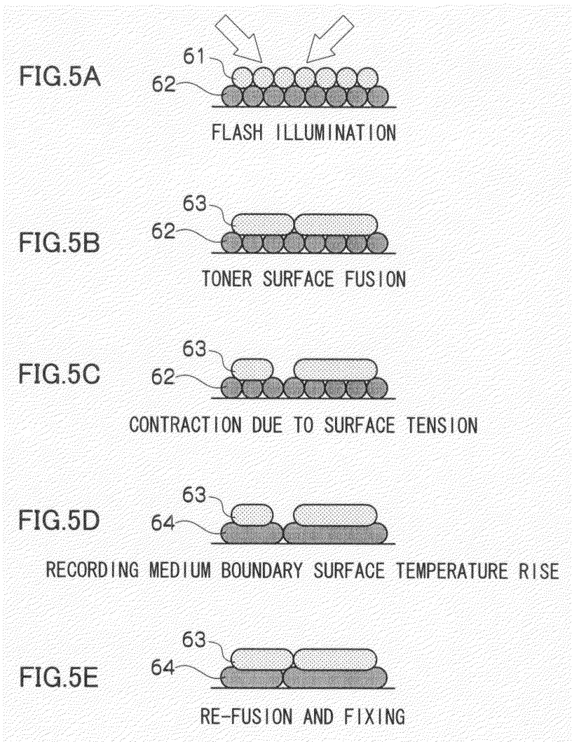

FIG. 4 is a graph showing changes in toner surface temperature and recording medium boundary surface temperature in the case in which the flash illumination by the flash fixing apparatus relating to the first exemplary embodiment is divided into three flashes. FIGS. 5A to 5E are conceptual views showing the transformation of the toner. Here, points A to E in FIG. 4 correspond to FIGS. 5A to 5E, and indicate toner surface temperatures and recording medium boundary surface temperatures of the states shown in FIGS. 5A to 5E.

Initially, when flash illumination is performed by the first xenon lamp group (see FIG. 5A), the surface of powdery yellow toner 61 exceeds a toner melting temperature (see FIG. 4) and the powdery yellow toner 61 becomes molten yellow toner 63, but the illumination energy is low enough that powdery magenta toner 62 does not melt (see FIG. 5B).

From then until the flash illumination by the second xenon lamp group, the toner temperature falls due to thermal radiation (see FIG. 4), and the molten yellow toner 63 coagulates due to surface tension (see FIG. 5C).

With the flash illumination of the second xenon lamp group, while the temperature of the molten yellow toner 63 is maintained, the powdery magenta toner 62 fuses and the recording medium boundary surface temperature rises to the toner melting temperature (see FIG. 5D). Molten magenta toner 64, which has fused, fixes onto the recording medium P.

Thereafter, the toners are again fused by a large illumination energy which is illuminated by the third xenon lamp group, and hence are fixed (see FIG. 5E).

Now, relationships between the toner surface temperature and medium temperature, which rise due to the energy of the flashes illuminated from the xenon lamps 38, and physical values of the recording medium P will be described. The physical values of the recording medium P are, for example, medium thickness, density and thermal conductivity.

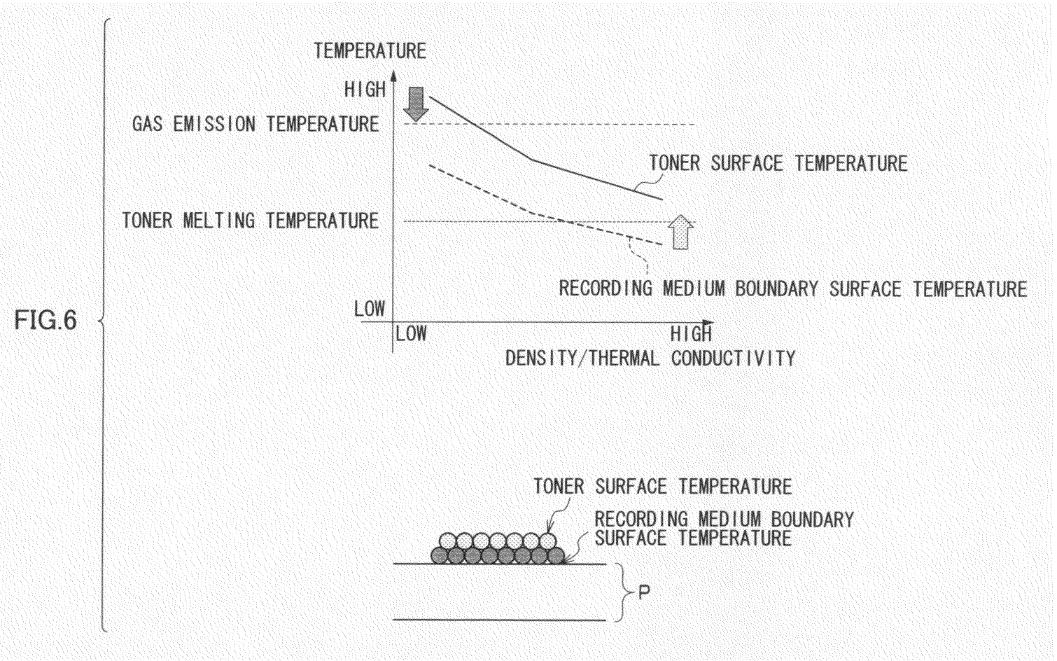

As shown in FIG. 6, if the energy of the flashes illuminated from the xenon lamps 38 and the thickness of the recording medium P are constant but the density of the recording medium P is higher, that is, if there are more air spaces in the recording medium P, then the toner surface temperature and the recording medium P boundary surface temperature will be lower. Further, if the thermal conductivity of the recording medium P is higher, the toner surface temperature and the recording medium P boundary surface temperature will be similarly lower.

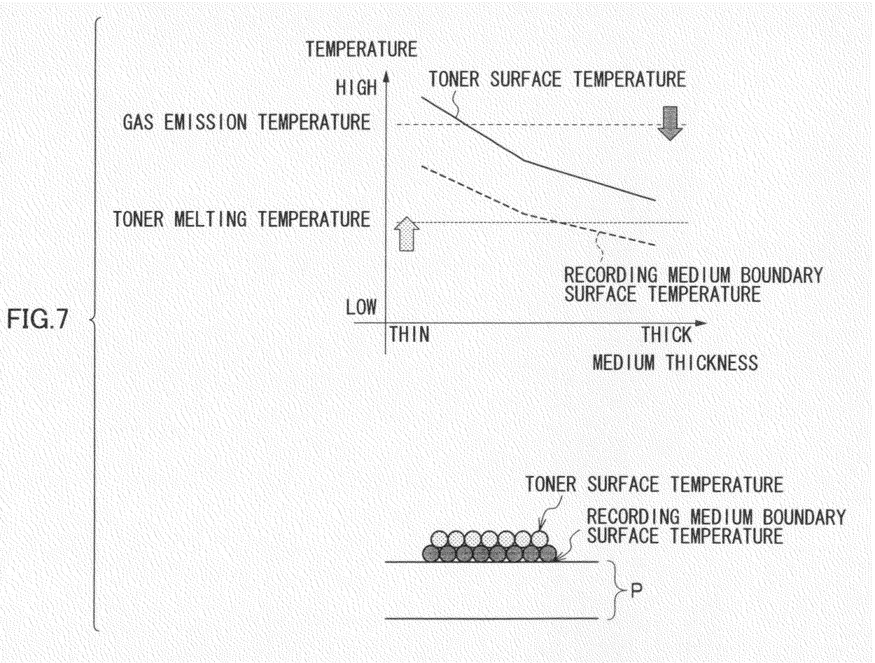

Furthermore, as shown in FIG. 7, if the energy of the flashes illuminated from the xenon lamps 38 and the density of the recording medium P are constant but the thickness of the recording medium P is higher, then the toner surface temperature and the recording medium P boundary surface temperature will drop.

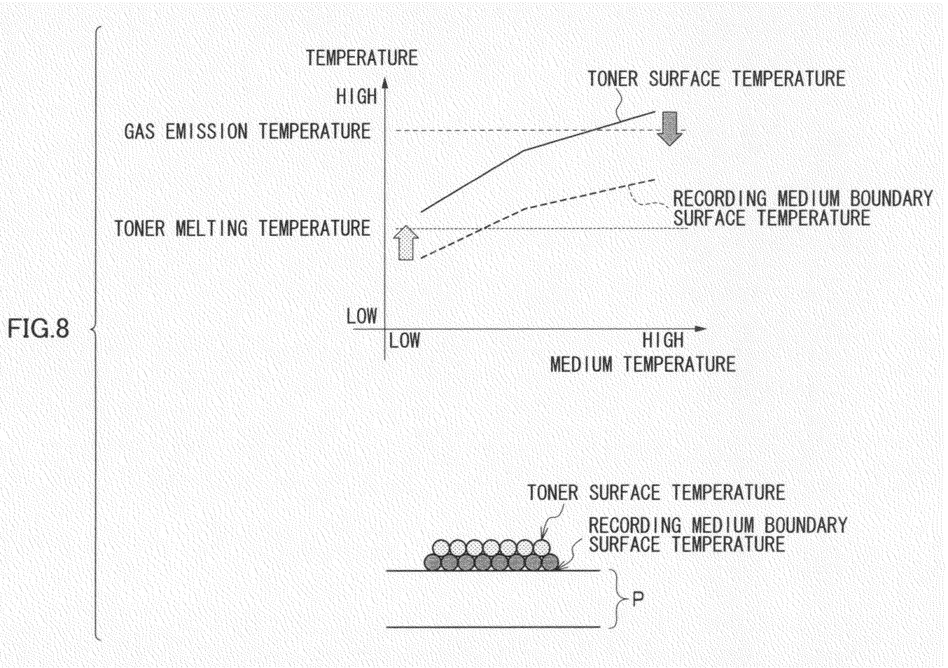

Further yet, as shown in FIG. 8, if the energy of the flashes illuminated from the xenon lamps 38 and the density of the recording medium P are constant but the temperature of the recording medium P is higher due to the ambient temperature of the surroundings, then the toner surface temperature and the recording medium P boundary surface temperature will rise.

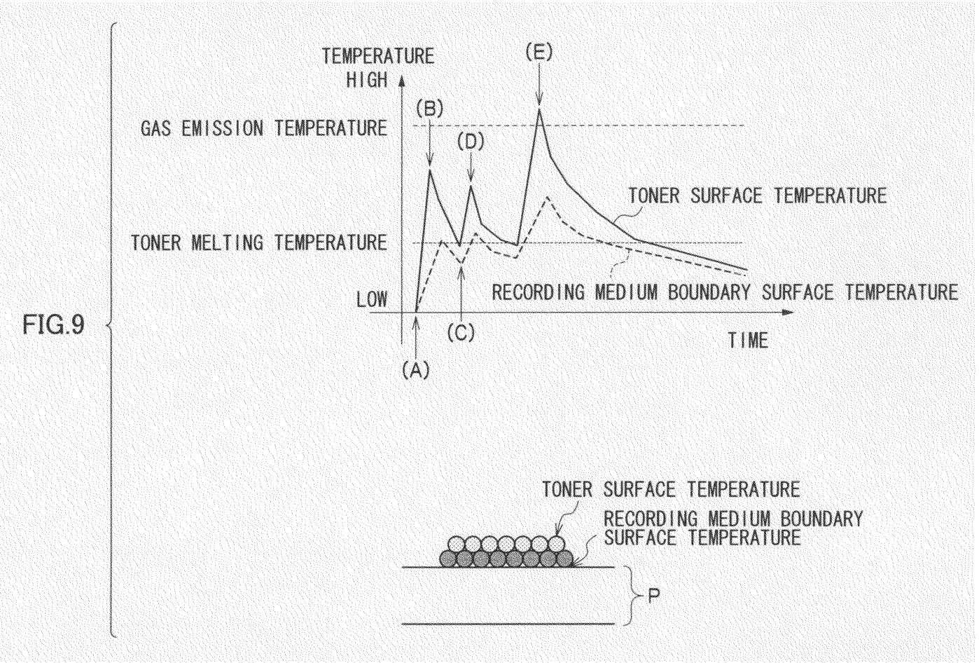

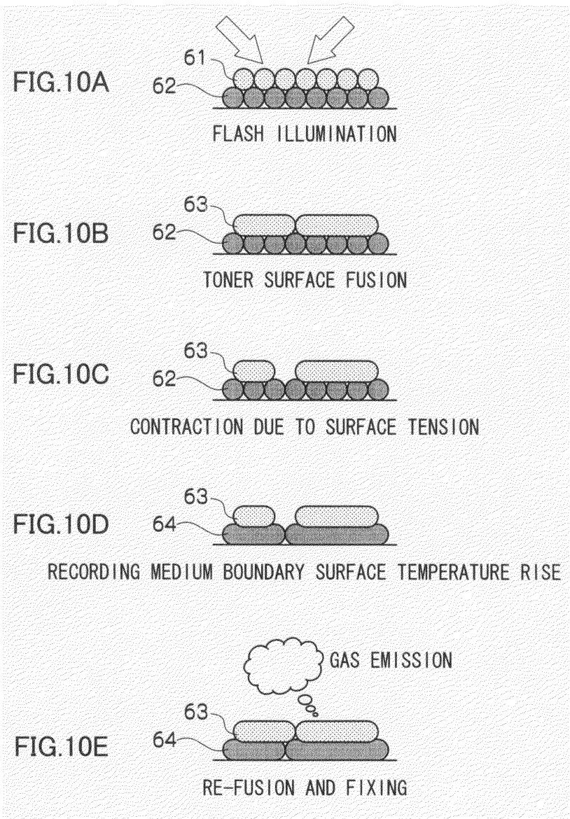

Therefore, if the density of the recording medium P is low, the thermal conductivity of the recording medium P is low, the thickness of the recording medium P is thick and/or the temperature of the recording medium P is high, when flash illuminations are performed by the first xenon lamp group, the second xenon lamp group and the third xenon lamp group, then as shown in FIGS. 9 and 10A to 10E, the toner surface reaches a gas emission temperature when the flash is illuminated by the third xenon lamp group, and gas is produced by toner sublimation.

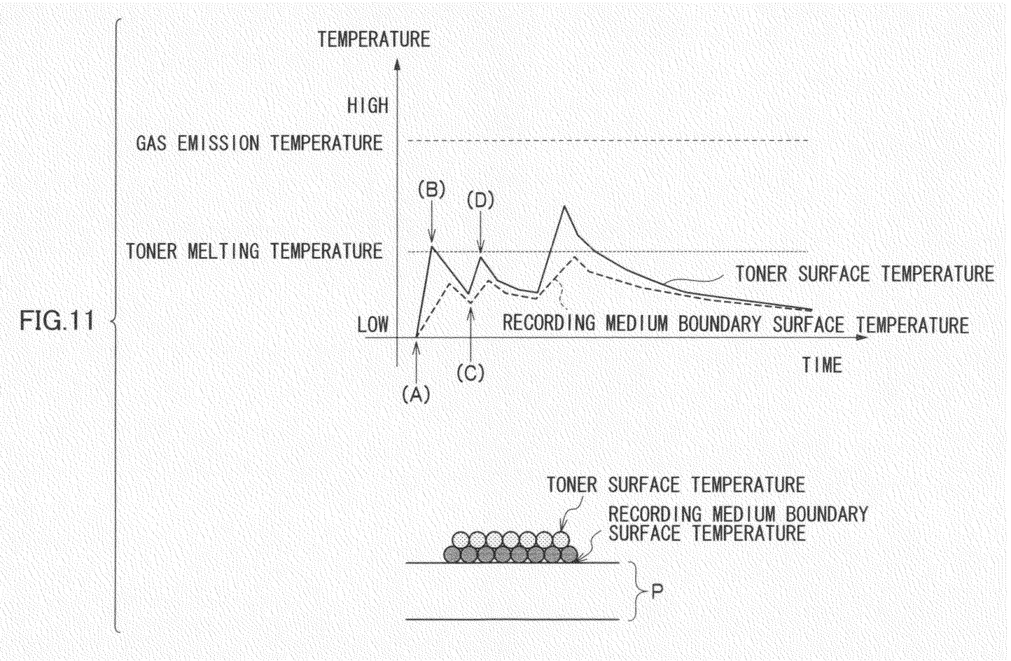

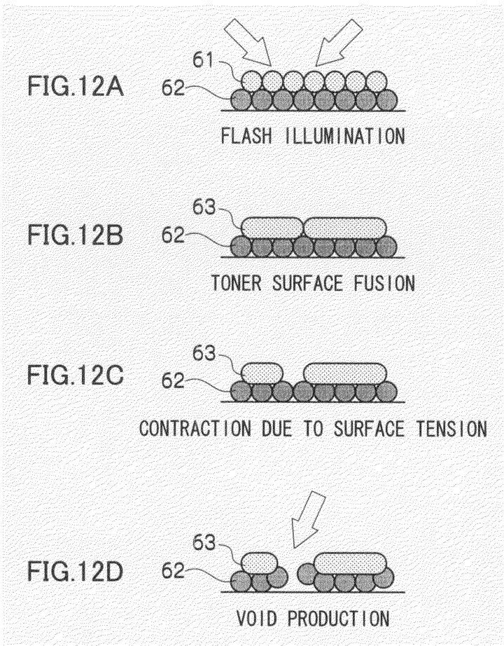

On the other hand, if the density of the recording medium P is high, the thermal conductivity of the recording medium P is high, the thickness of the recording medium P is thin and/or the temperature of the recording medium P is low, when flash illuminations are performed by the first xenon lamp group, the second xenon lamp group and the third xenon lamp group, then as shown in FIGS. 11 and 12A to 12D, flash illumination is performed by the first xenon lamp group (see FIG. 12A) and the surface of the powdery yellow toner 61 exceeds the toner melting temperature to form the molten yellow toner 63 but the powdery magenta toner 62 in the lower layer does not fuse (see FIG. 12B).

Thereafter, when flash illumination is performed by the second xenon lamp group, the boundary surface temperature of the recording medium does not reach the toner melting temperature and the molten yellow toner 63 coagulates due to surface tension (see FIG. 12C). Because of the surface tension of the molten yellow toner 63, the powdery magenta toner 62 in the lower layer is stretched and cavities, known as voids, are produced, which cause the image to detach (see FIG. 12D).

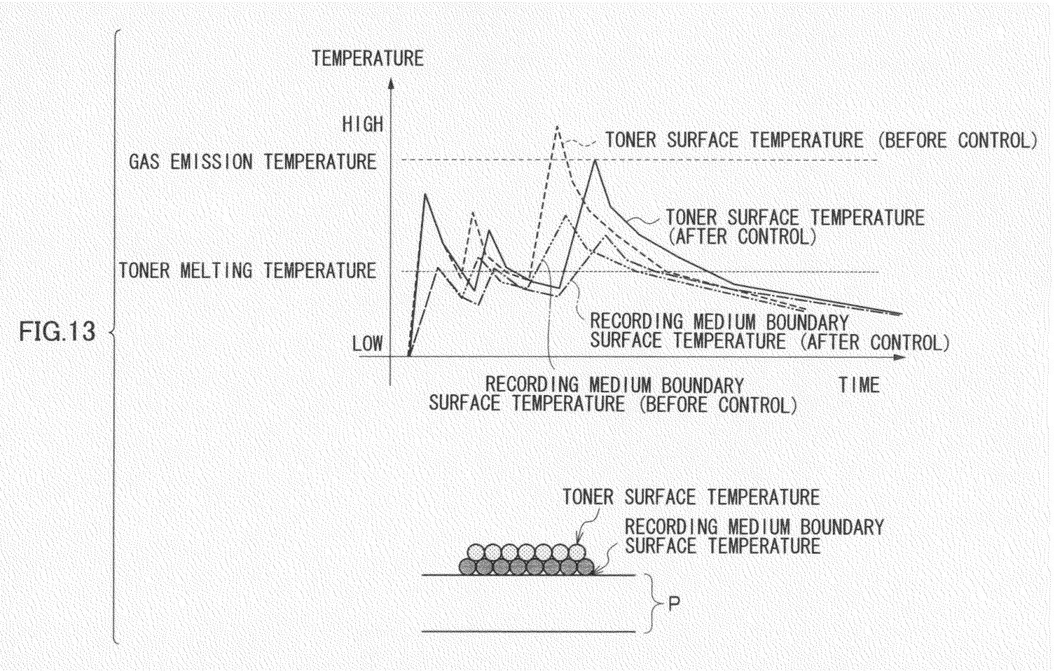

Accordingly, in the first exemplary embodiment, if the density of the recording medium P is low, the thermal conductivity of the recording medium P is low, the thickness of the recording medium P is thin and/or the temperature of the recording medium P is high, the emission timings of the second xenon lamp group and the third xenon lamp group are delayed. Thus, as shown in FIG. 13, the time for thermal radiation is lengthened and the toner surface temperature and the recording medium P boundary surface temperature are lowered.

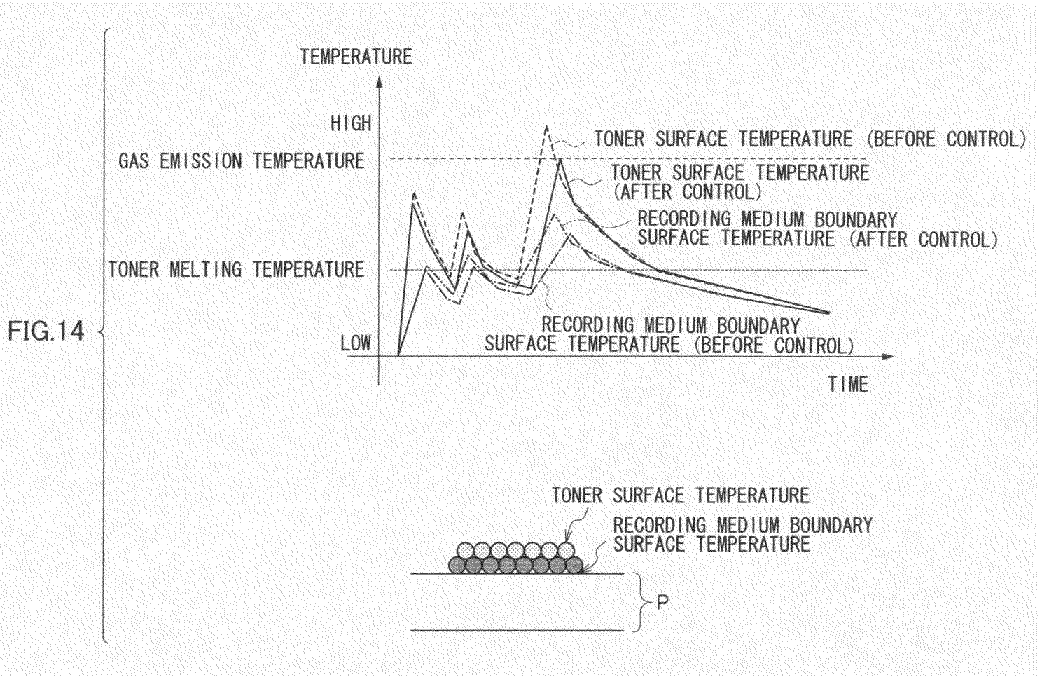

For such a case, a structure may be used in which, by lowering FV voltages supplied to the second xenon lamp group and the third xenon lamp group in addition to delaying the emission timings of the second xenon lamp group and the third xenon lamp group, as shown in FIG. 14, the time for radiation is lengthened and the toner surface temperature and the recording medium P boundary surface temperature are lowered.

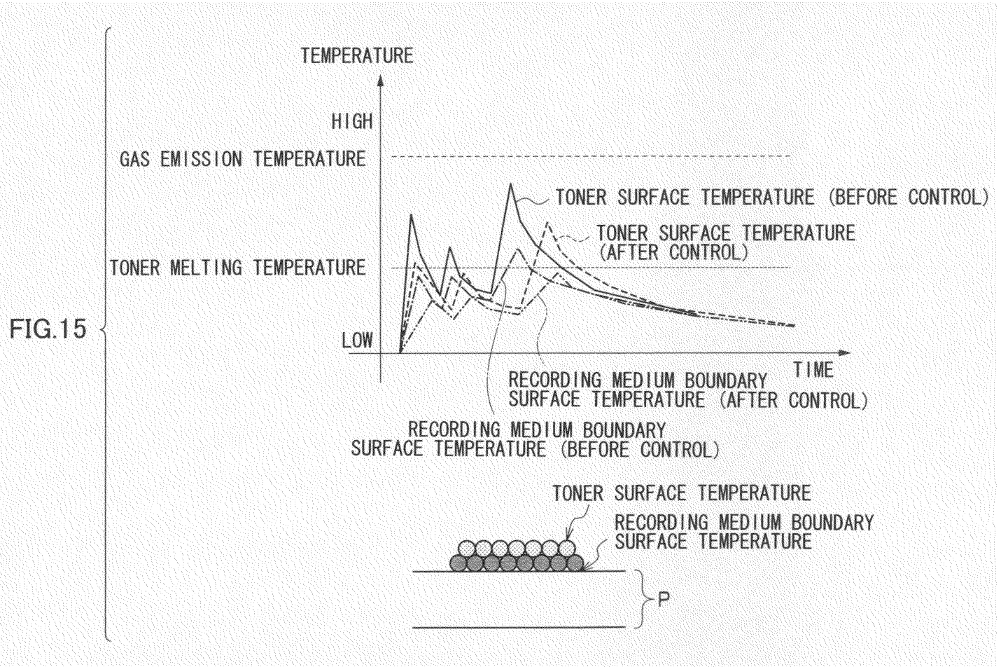

Further, in the first exemplary embodiment, if the density of the recording medium P is high, the conductivity of the recording medium P is high, the thickness of the recording medium P is thick and/or the temperature of the recording medium P is low, the emission timings of the second xenon lamp group and the third xenon lamp group are advanced. Thus, as shown in FIG. 15, the time for thermal radiation is shortened and the toner surface temperature and the recording medium P boundary surface temperature are raised.

Thus, although the recording medium P boundary surface temperature would not reach the toner melting temperature before control for controlling the emission timings, after control for controlling the emission timings, the recording medium P boundary surface temperature may exceed the toner melting temperature.

Next, a specific process for controlling the emission timings of the xenon lamp groups will be described.

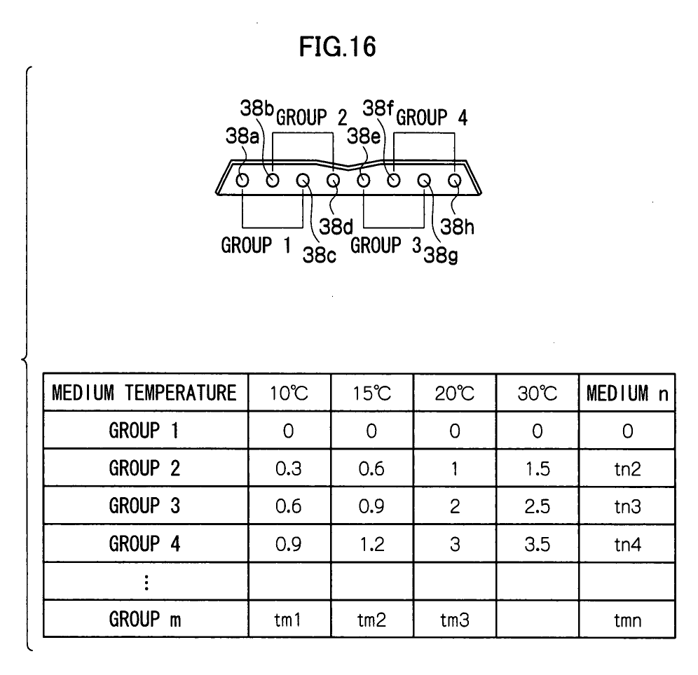

Firstly, fixing characteristics and surface conditions of various recording mediums P are evaluated beforehand and suitable emission timings are determined. For example, as shown in FIG. 16, delay durations of emission timings of xenon lamp groups are specified in accordance with medium temperatures of recording mediums P in a table.

The table of FIG. 16 shows relative time differences of other groups with respect to a first group, with the xenon lamps 38 being divided into groups 1 to 4. Here, of the xenon lamps 38a to 38h, the xenon lamps 38a and 38c are a first xenon lamp group, the xenon lamps 38b and 38d are a second xenon lamp group, the xenon lamps 38e and 38g are a third xenon lamp group and the xenon lamps 38f and 38h are a fourth xenon lamp group.

An operator first selects one set of emission timings to suit a medium temperature of the recording medium P from the table of specified emission timings in the controller 36. Alternatively, a structure may be used in which a medium temperature of the recording medium P is measured in the image formation device 10, and the controller 36 selects emission timings from the table of emission timings in accordance with that medium temperature.

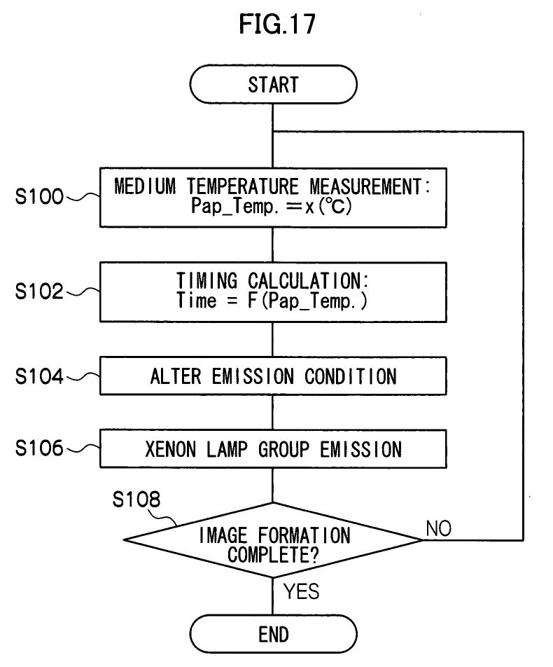

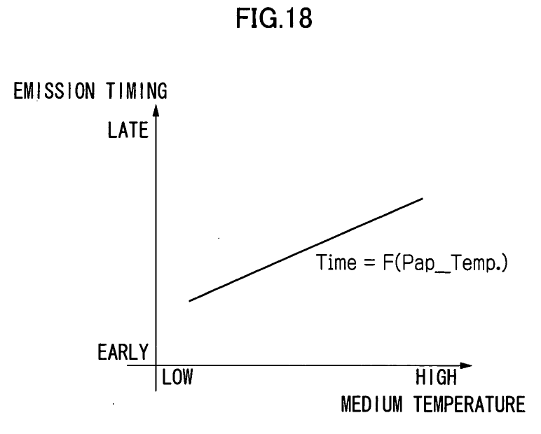

Further, as shown in FIGS. 17 and 18, a structure may be used in which the medium temperature of the recording medium P is continuously measured, the emission timings are determined from the temperature by an arithmetic formula which has been determined beforehand, the emission timings of the xenon lamps 38 are altered, and light is emitted.

As a control sequence, as shown in FIG. 17, first, the medium temperature of the recording medium P is measured in step 100. The medium temperature is desirably measured immediately before conveyance to the flash fixing apparatus 30; for example, the medium temperature of the recording medium P is measured after the transfer of the toner image. It is further desirable for the medium temperature of the recording medium P to be measured non-contactingly.

In step 102, an emission timing is calculated by a function F in which the medium temperature, that is, “Pap_Temp.” is a variable. The function F is, for example, a first order function as shown in FIG. 18.

In step 104, a light-emitting condition of a xenon lamp group, that is, the emission timing is altered. In step 106, the xenon lamp group is caused to emit light in accordance with the altered light emission condition.

In step 108, it is judged whether image formation has finished, and if image formation has not finished, the process returns to step 100.

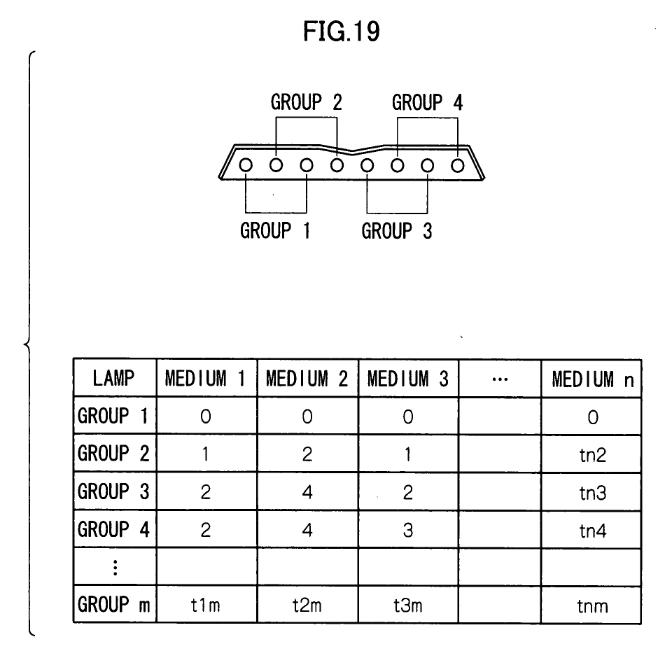

The delay durations of the emission timings of the xenon lamp groups may also be specified in a table in accordance with physical values of the recording medium P other than the medium temperature of the recording medium P, for example, thickness, thermal conductivity and density of the recording medium P, as shown in FIG. 19.

For example, the delay durations of the emission timings of the xenon lamp groups are specified in the table shown in FIG. 19 for medium 1 with a basis weight of 200 gsm, medium 2 with a basis weight of 157 gsm, and medium 3 with a basis weight of 64 gsm. Here, for example, so-called NIP paper is employed as mediums 1, 2 and 3.

Now, because the thickness of a recording medium P is proportional to the basis weight of the recording medium P, here, and the table is normalized in accordance with the basis weight of this recording medium P instead of the thicknesses of the recording mediums P. In the table of FIG. 19, similarly to the table of FIG. 16, delay durations of other groups relative to a first group when the xenon lamps 38 are divided into groups 1 to 4 are shown.

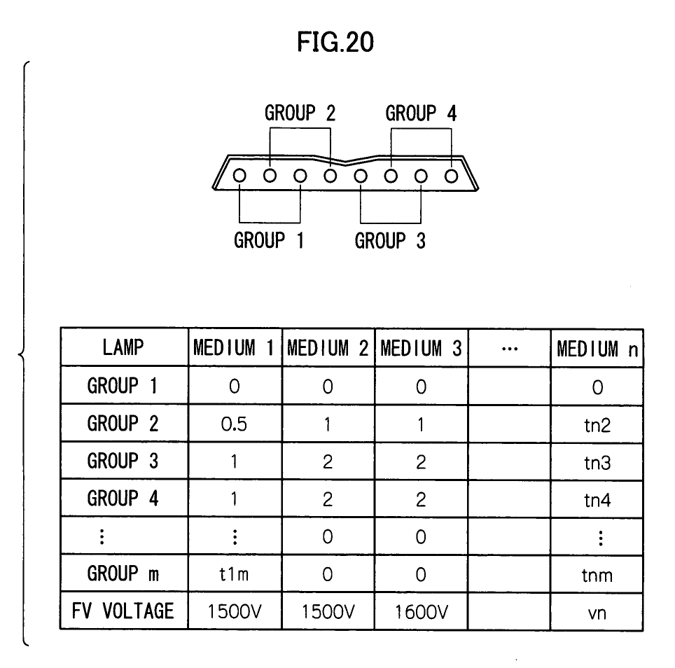

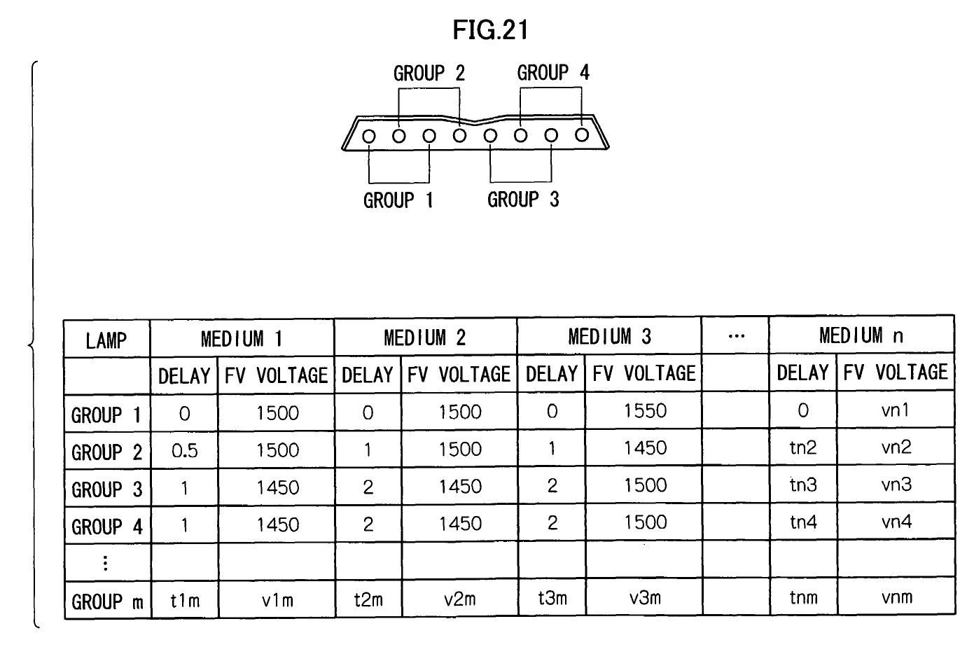

A structure may be used in which, as shown in FIGS. 20 and 21, the emission conditions for respective recording mediums are specified with, in addition to the alterations of the emission timings, the FV voltages being altered.

As shown in FIG. 20, an FV voltage for the xenon lamp groups is specified for each recording medium P. The delay durations of the emission timings of the xenon lamp groups are specified in the table shown in FIG. 20 for medium 1 with the basis weight of 200 gsm, medium 2 with the basis weight of 157 gsm, and medium 3 with the basis weight of 64 gsm. For example, for medium 1 and medium 2, the FV voltages are set to 1500 V, and for medium 3, the FV voltages are set to 1600 V. Here, so-called NIP paper is employed as mediums 1, 2 and 3.

In the example shown in FIG. 21, in addition to the alterations of the emission timings, the FV voltages are specified for each xenon lamp group. For example, for mediums 1 and 2, the FV voltage is set to 1500 V for the first xenon lamp group and the second xenon lamp group, and is set to 1450 V for the third xenon lamp group and the fourth xenon lamp group. Thus, a structure may be used in which the FV voltage differs between the xenon lamp groups.

### —Operation of the First Exemplary Embodiment—

Next, operation of the above-described first exemplary embodiment will be described.

According to the first exemplary embodiment, the plural xenon lamp groups emit light with different light emission timings, illuminate flashes at the recording medium P, and fix the toner image that has been transferred to the recording medium P. The controller 36 alters the emission timings of the xenon lamp groups in accordance with physical characteristics of the recording medium P such as, for example, medium temperature, thermal conductivity, density and the like.

Further, voltages supplied to the xenon lamps 38 are altered together with the alterations of emission timings, in accordance with physical characteristics of the recording medium P such as, for example, medium temperature, thermal conductivity, density and the like.

### Second Exemplary Embodiment

Next, a second exemplary embodiment of the present invention will be described. Here, portions that are the same as in the first exemplary embodiment are assigned the same reference numerals, and descriptions thereof will not be given. Furthermore, because overall structure of an image formation device is the same as in the first exemplary embodiment, description thereof will not be given.

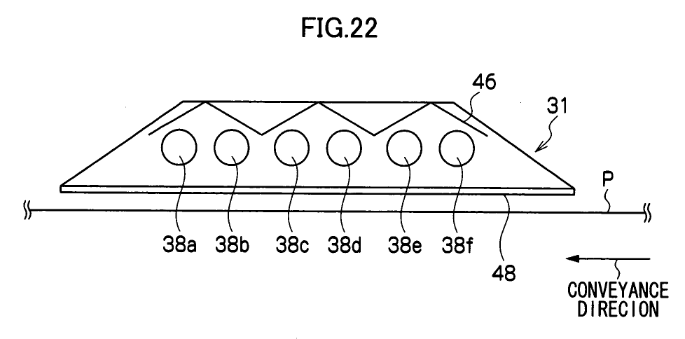

A flash fixing apparatus 31 relating to the second exemplary embodiment is provided, as shown in FIG. 22, with six of the xenon lamps 38. Each xenon lamp 38 is oriented such that a length direction thereof, which is to say an axial direction thereof, is along a width direction of the recording medium P, which is to say a direction intersecting the conveyance direction of the recording medium P, and the xenon lamps 38 are arranged with a constant spacing along the conveyance direction of the recording medium P. Further, at a rear face side of the xenon lamps 38 as viewed from the conveyance path side of the recording medium P, the reflection plate 46 is provided. The reflection plate 46 has a form which encloses the rear face side of the six xenon lamps 38 and is formed with an opening at the front face side, that is, the conveyance path side of the xenon lamps 38. The reflection plate 46 reflects flash light that is illuminated to the rear face side from the xenon lamps 38 toward the conveyance path side.

Further, each xenon lamp 38 is connected with the driving circuit 50, similarly to the first exemplary embodiment, and the driving circuit 50 is controlled by the controller 36 which serves as an emission controller. The controller 36 controls the driving circuit 50, and thus controls the voltage that is supplied to the xenon lamp 38 and the emission timing of the xenon lamp 38. Note that the driving circuit 50 is not shown in FIG. 22.

In the second exemplary embodiment, of the xenon lamps 38a to 38f, the xenon lamps 38a, 38c and 38e serve as a first xenon lamp group and the xenon lamps 38b, 38d and 38f serve as a second xenon lamp group.

The two xenon lamps 38a and 38b illuminate flashes at a same area of the recording medium P. Similarly, the two xenon lamps 38c and 38d illuminate flashes at a same area of the recording medium P and the two xenon lamps 38e and 38f illuminate flashes at a same area of the recording medium P. The reflection plate 46 has a form which reflects flash light emitted to the rear face side from the xenon lamps 38 to respective illumination regions of the two xenon lamps 38a and 38b, the two xenon lamps 38c and 38d and the two xenon lamps 38e and 38f.

The cover glass 48 is disposed at the front face side of the xenon lamps 38, that is, the conveyance path side thereof. The cover glass 48 is provided so as to close off the opening of the reflection plate 46. Ingression of dust and the like into the interior of the flash fixing apparatus 31 is blocked by the cover glass 48.

Now, surface temperatures of black toner and color toner when flashes are illuminated from the xenon lamps 38 will be described.

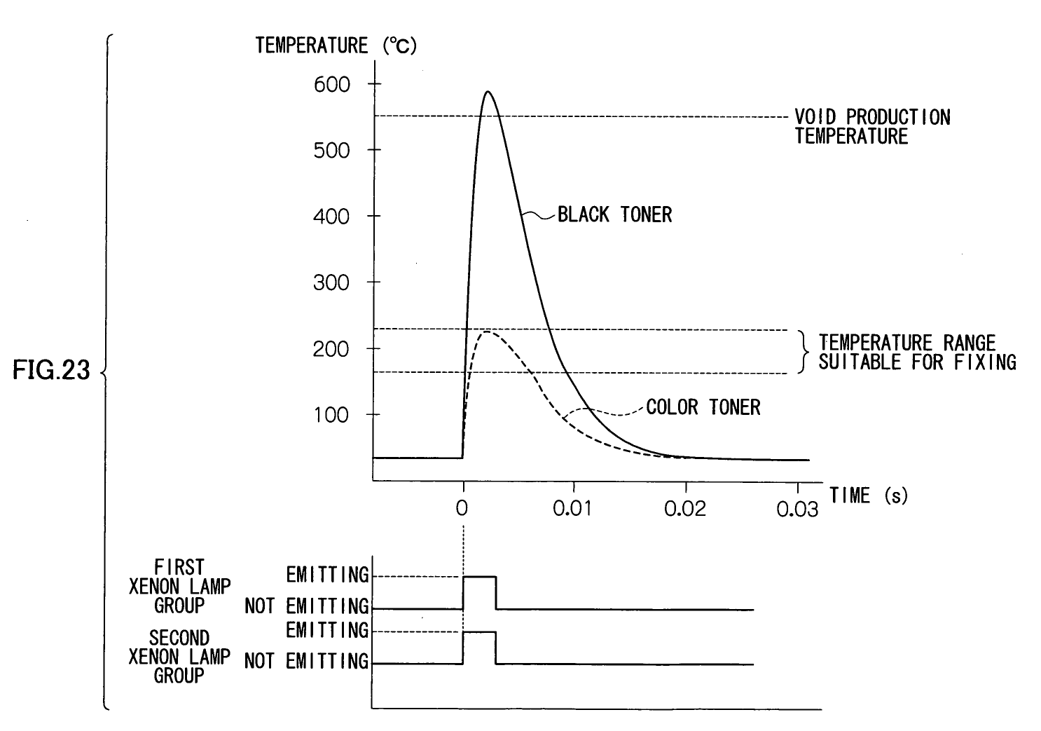

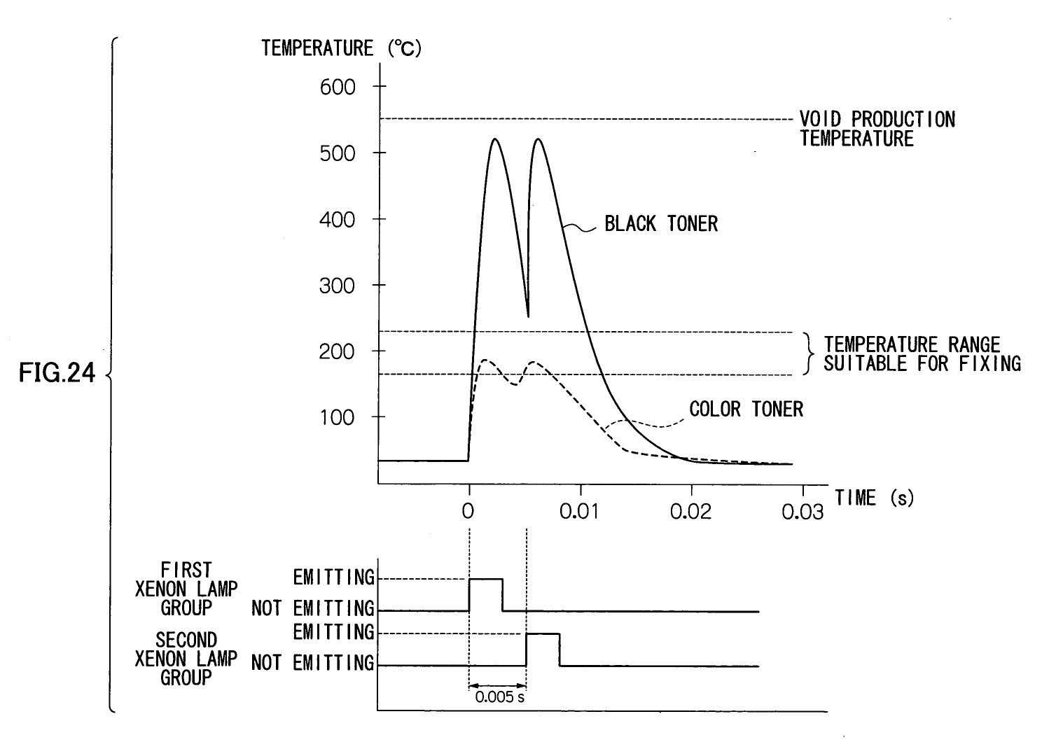

FIG. 23 shows conditions of toner temperature when the first xenon lamp group and the second xenon lamp group are caused to emit light simultaneously. FIG. 24 shows conditions of toner temperature when the first xenon lamp group and the second xenon lamp group are caused to emit light with the emission timings being offset.

As shown in FIG. 23, in the case in which the first xenon lamp group and the second xenon lamp group are caused to emit simultaneously, the temperature of the black toner rises sharply. Consequently, toner components, for example, water which is contained in the toner, sublimate. Therefore, a deterioration in image quality, such as dot-form dropouts known as voids or the like, occurs in the image formed on the recording medium. On the other hand, the color toner reaches into a temperature range suitable for fixing, and is excellently fixed.

As shown in FIG. 24, in the case in which light is emitted with the emission timings of the xenon lamp groups being offset, in comparison with the case in which the first xenon lamp group and the second xenon lamp group emit simultaneously, a duration of the black toner in the temperature range suitable for fixing is longer, and a temperature at a peak time is suppressed. Therefore, the black toner is excellently fixed. On the other hand, there is a time band in which the color toner is below the temperature range suitable for fixing, and the color toner is not excellently fixed.

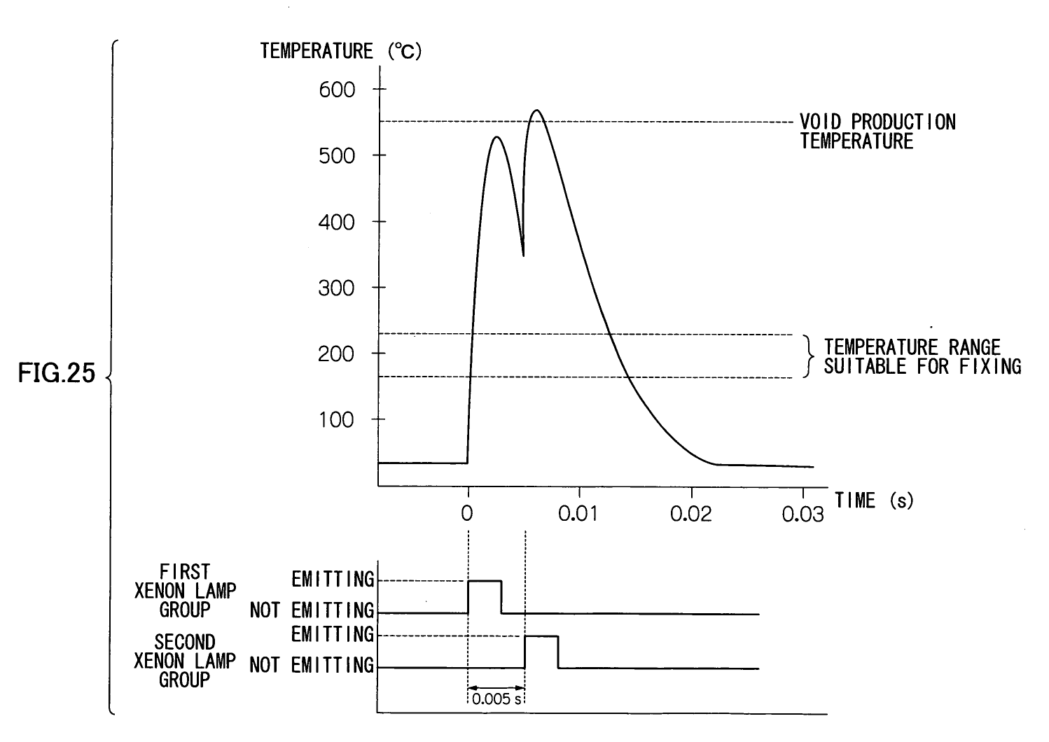

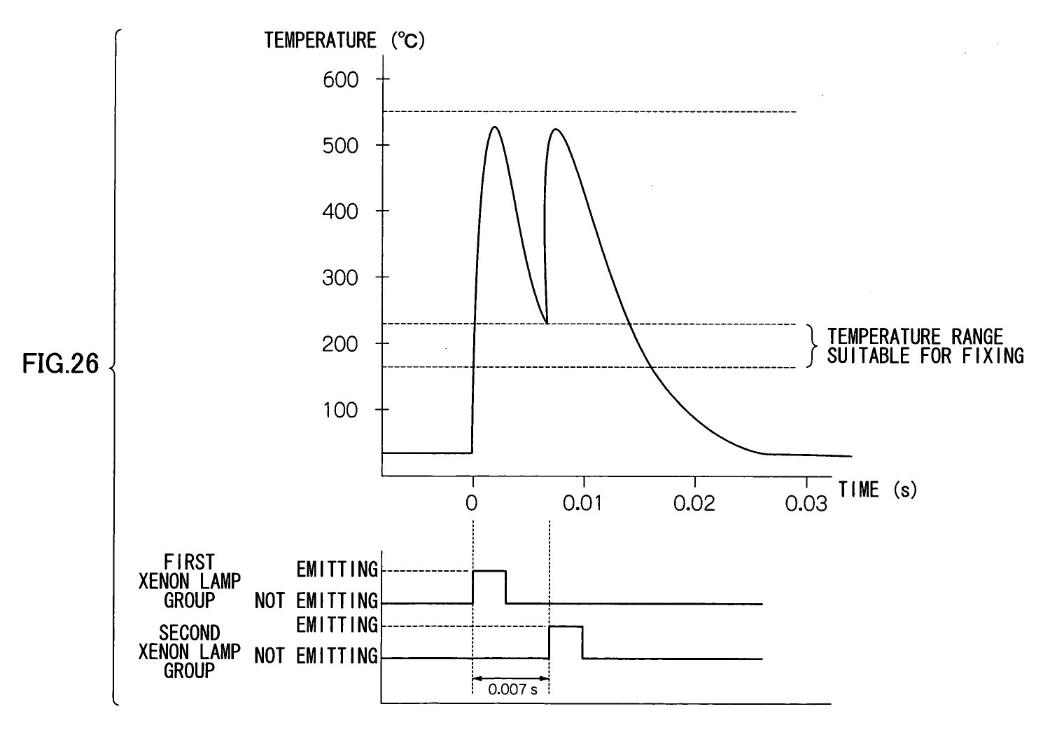

FIGS. 25 and 26 show surface temperatures of black toner in cases in which colored paper is employed for the recording medium P.

When the recording medium P is pre-printed paper, colored paper or the like, thermal absorptivity according to characteristics of the recording medium P will be higher. Therefore, in comparison with the conditions of FIG. 24, the recording medium P itself absorbs more heat, and a cooling period of heat generated by the first emission, which the first xenon lamp group has emitted, is longer. Consequently, a period in which the recording medium P is above temperatures suitable for toner fusing due to the second emission is lengthened, a peak temperature is higher, and thus voids may be produced.

As shown in FIG. 26, a peak of toner temperature may be suppressed by increasing an emission time difference, and voids may be prevented.

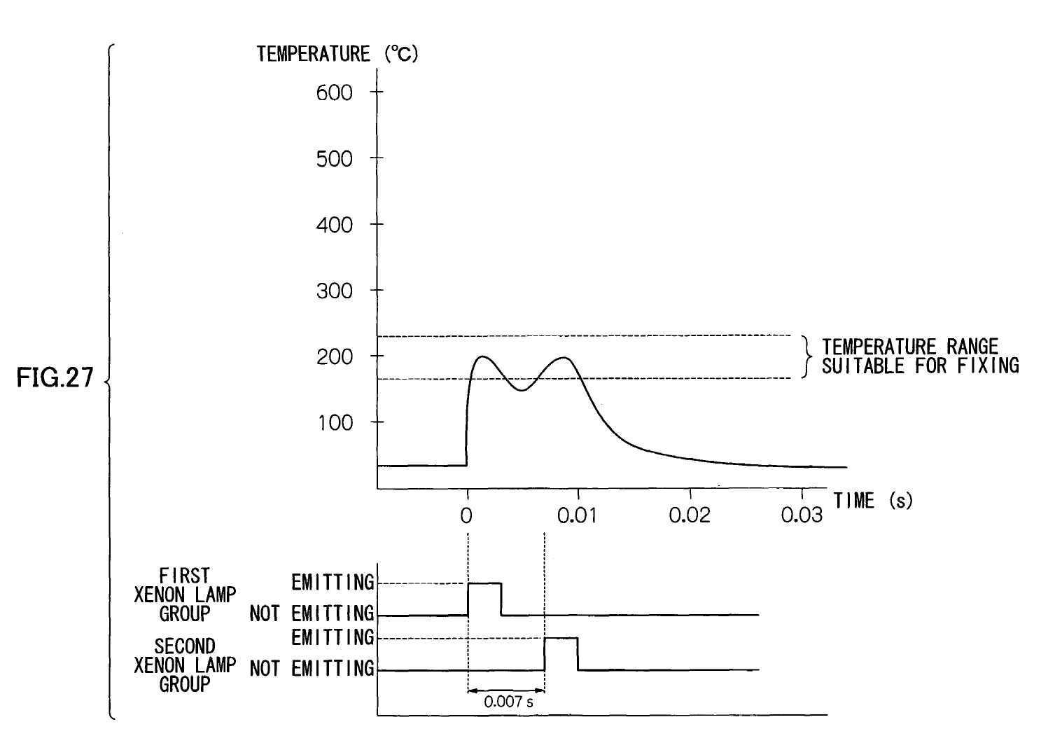

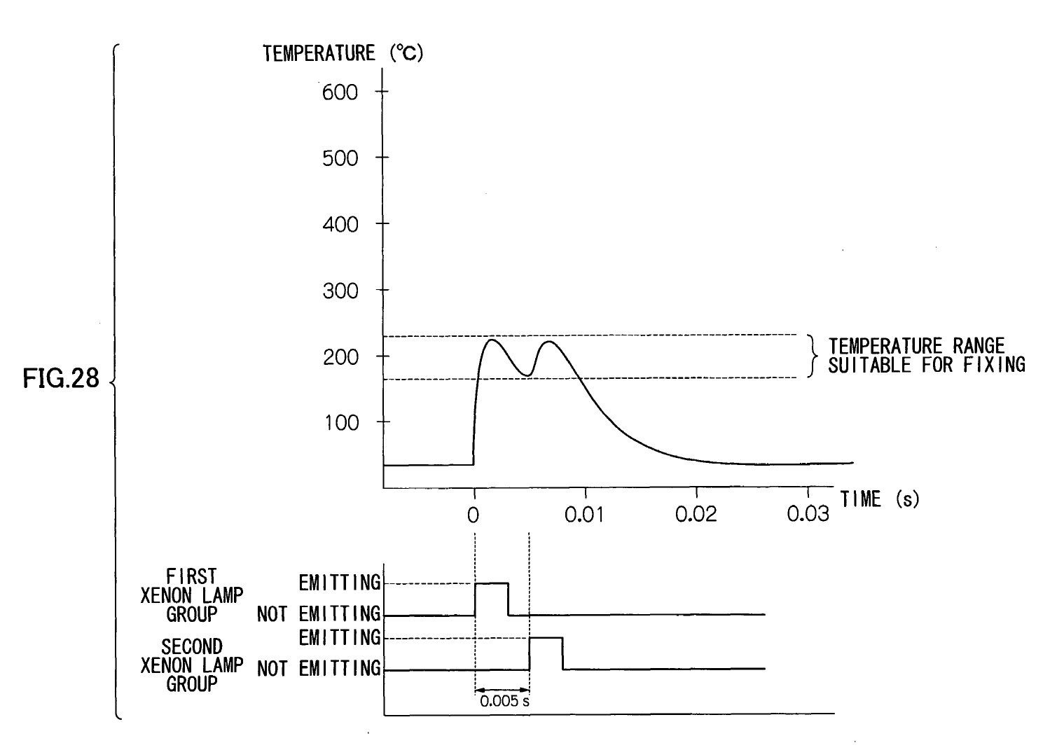

In a case of color toner with low thermal absorptivity, if an emission time difference between the first and second emissions is large as shown in FIG. 27, a duration in which the temperature reaches the temperature range suitable for fixing is not sufficient, and fixing is not excellent. In such a case, fixing processing at a suitable temperature may be carried out by reducing the emission time difference as shown in FIG. 28. Herein, the temperature range suitable for fixing means a temperature band which is appropriate for fusing of toner.

Next, a structure in which emission timings of the xenon lamps 38 are altered in accordance with the toner in the toner image and physical characteristics of the recording medium will be described.

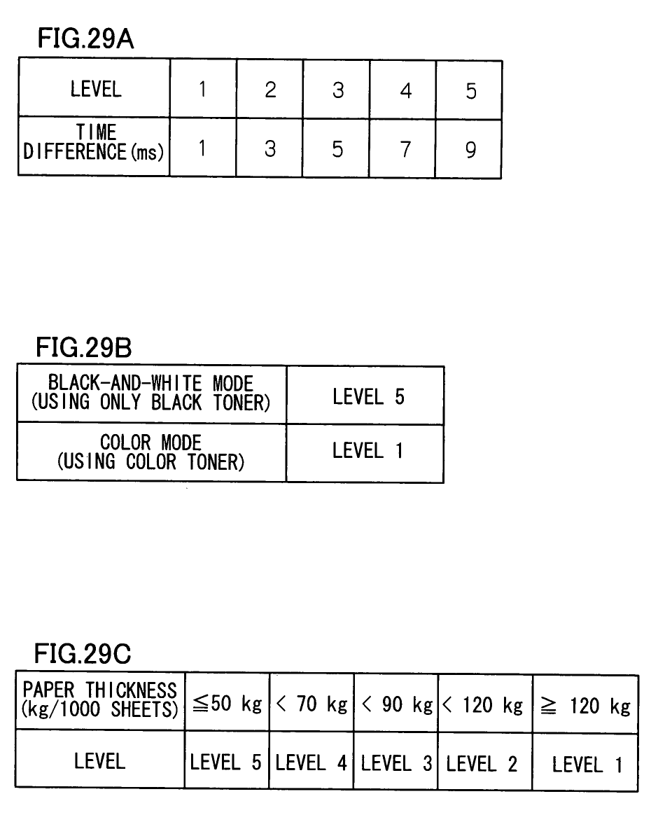

In the present exemplary embodiment, a time difference t (ms) between the first emission and the second emission is set into level divisions, and a level division value is applied in accordance with the toner in the toner image and the physical characteristics of the recording medium as described below (see FIG. 29A).

For a level 1, the time difference between the first emission and the second emission is set to, for example, 1 ms, the emission time difference is small, and this is applied to a case in which application of the thermal energy in a short period is required. In contrast, for a level 5, the time difference between the first emission and the second emission is set to, for example, 9 ms, the emission time difference is large, and this is applied to a case in which application over a relatively long period is required.

The second exemplary embodiment is structured such that an operator inputs from an operation panel to set the above-described levels. However, an input unit for setting these levels may employ a different system. For example, a structure may be used in which the image formation device 10 measures a temperature of the recording medium P, and the image formation device 10 carries out level setting automatically, that is, without operation by an operator.

Black toner of a black-and-white image has high thermal absorptivity, and consequently is likely to produce voids if heated in a short period. In contrast, color toner of a color image has lower thermal absorptivity, and therefore will not reach an excellent fusing temperature if not heated in a short period. Accordingly, as shown in FIG. 29B, level 1 is employed for a black-and-white image and level 5 is employed for a color image.

In a case in which the thickness of a paper serving as the recording medium P is thick, in comparison with a thinner case, a heat capacity is greater and the radiated heat is more likely to be conducted into the paper. Therefore, a period of decrease of toner temperature is short.

Accordingly, as shown in FIG. 29C, if, for example, the weight of 1,000 sheets of the paper is 50 kg or less, level 5 is used, if it is from 50 kg to 70 kg, level 4 is used, if it is from 70 kg to 90 kg, level 3 is used, if it is over 90 kg and less than 120 kg, level 2 is used, and if it is 120 kg or more, level 1 is used.

When a flash passes through a toner layer and reaches the recording medium P, heat absorption varies in accordance with a color of the recording medium P. If absorption is good, the toner will tend to melt due to heat absorbed by the recording medium P itself. Therefore, in a case in which the absorption is good, it is necessary for an emission interval to be wider to allow for a heat radiation period.

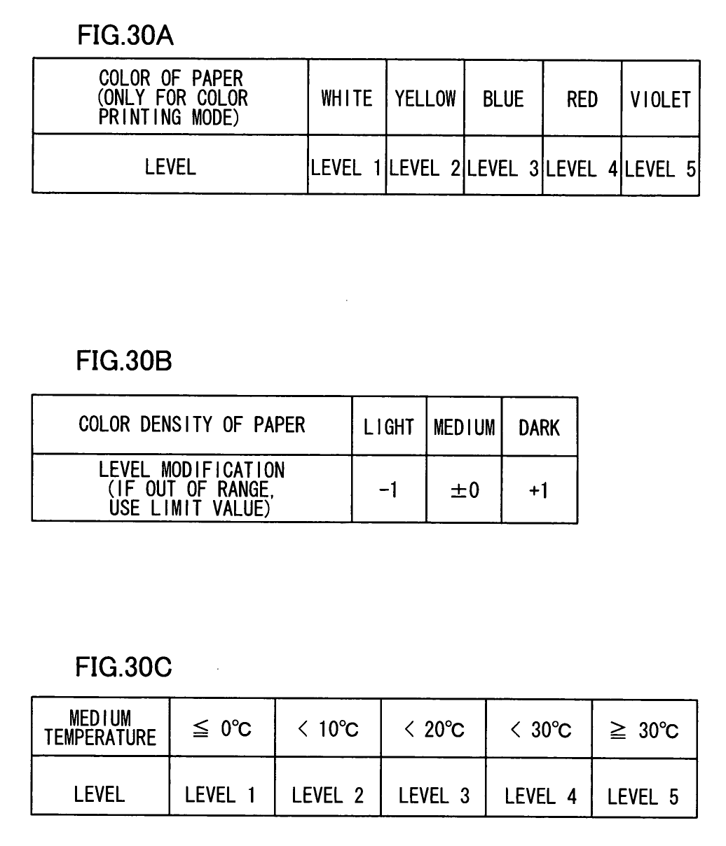

Correspondingly, as shown in FIG. 30A, level 1 is used when the color of the recording medium P is white, level 2 is used when the color of the recording medium P is yellow, level 3 is used when the color of the recording medium P is blue, level 4 is used when the color of the recording medium P is red, and level 5 is used when the color of the recording medium P is violet.

Moreover, as shown in FIG. 30B, because the absorption characteristic is also affected by color density of the recording medium P, an adjustment calculation is applied to the level of a particular color. If the color density is light, the level is lowered by one step, and if it is dark, the level is raised by one step. For example, if a recording medium P is blue with a light color density, level 2 is used, and if a recording medium P is red with a dark color density, level 5 is used.

Because the range of levels is from 1 to 5, if the level range is exceeded, for example, in a case of violet with color density being dark, level 5, which is a limit value of the level range, is set. Herein, an operator judges the darkness/lightness of a color visually and selects a color density from the operation panel.

The temperature of the recording medium P is affected by storage conditions of the recording medium P. If the temperature of the recording medium P is lower, then the temperature of the transferred toner is lower, and the toner might not reach an excellent fusing temperature. Accordingly, if the temperature is low, the emission interval is shortened such that the fusing temperature will be excellent.

Correspondingly, as shown in FIG. 30C, level 1 is used when the temperature of the recording medium P is 0° C. or less, level 2 is used when the temperature of the recording medium P is from 0° C. to 10° C., level 3 is used when the temperature of the recording medium P is from 10° C. to 20° C., level 4 is used when the temperature of the recording medium P is between 20° C. and 30° C., and level 5 is used when the temperature of the recording medium P is 30° C. or more.

Herein, in a case in which a difference between levels according to a combination of the above descriptions occurs, for a case of black toner, application in a direction of void prevention, that is, a maximum level, is desirable, and for a case of color toner, application in a direction of preventing non-excellent fixing, that is, a minimum level, is desirable.

### —Operation of the Second Exemplary Embodiment—

Next, operation of the above-described second exemplary embodiment will be described.

According to the second exemplary embodiment, plural xenon lamp groups emit light with different light emission timings, illuminate flashes at the recording medium P, and fix the toner image that has been transferred to the recording medium P. The controller 36 alters the emission timings of the xenon lamp groups in accordance with whether the toner image is a black-and-white image or a color image. The emission timings of the xenon lamp groups are also altered in accordance with physical characteristics of the recording medium P such as, for example, coloration of the medium, thickness of the medium and temperature of the medium.

In the above-described first exemplary embodiment, eight of the xenon lamps 38 are provided, and in the second exemplary embodiment, six are provided. However, a number of the xenon lamps 38 is not limited to these, and structures may be used with two to five thereof, or seven, or nine or more.

Further, in the first and second exemplary embodiments, the length direction of the xenon lamps 38, that is, the axial direction thereof, is oriented along the width direction of the recording medium P, that is, the direction intersecting the conveyance direction of the recording medium P. However, structures may be used in which the length direction of the xenon lamps 38, that is, the axial direction, is disposed along the conveyance direction of the recording medium P, and structures may be used in which the length direction of the xenon lamps 38, that is, the axial direction, is disposed at an angle to the width direction of the recording medium P.

Further, in the above-described first exemplary embodiment, the xenon lamps 38 are divided into three xenon lamp groups and, each time a toner image on a predetermined region of a recording medium P is to be fixed, the xenon lamps 38 emit three emissions. In the second exemplary embodiment, the xenon lamps 38 are divided into two xenon lamp groups and, each time a toner image on a predetermined region of a recording medium P is to be fixed, the xenon lamps 38 emit two emissions. However, structures may also be used in which the xenon lamps 38 are divided into four or more xenon lamp groups and, each time a toner image on a predetermined region of a recording medium P is to be fixed, the xenon lamps 38 emit four or more emissions.

Further, in the first and second exemplary embodiments, the xenon lamp groups are constituted with two to four xenon lamps 38, but any structure may be used provided the xenon lamp groups are constituted with one or more xenon lamps 38.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. A flash fixing apparatus comprising:
a plurality of lamp groups each comprising at least one lamp, the each lamp group illuminating a flash at a recording medium to fix a toner image which has been transferred to the recording medium; and
an emission controller that causes the lamp groups to emit light with different emission timings, and that alters the emission timings in accordance with a toner of the toner image and a physical characteristic of the recording medium.

2. The flash fixing apparatus of claim 1, wherein the emission controller alters voltages supplied to the lamp groups in accordance with the toner of the toner image and the physical characteristic of the recording medium.

3. The flash fixing apparatus of claim 1, wherein the emission controller alters the emission timings in accordance with a temperature of the recording medium.

4. The flash fixing apparatus of claim 1, wherein the emission controller alters the emission timings in accordance with a thickness of the recording medium.

5. The flash fixing apparatus of claim 1, wherein the emission controller alters the emission timings in accordance with a density of the recording medium.

6. The flash fixing apparatus of claim 1, wherein the emission controller alters the emission timings in accordance with a thermal conductivity of the recording medium.

7. The flash fixing apparatus of claim 1, wherein the emission controller alters the emission timings in accordance with whether the toner image is a black-and-white image or a color image.

8. The flash fixing apparatus of claim 1, wherein the emission controller alters the emission timings in accordance with a heat capacity of the recording medium.

9. The flash fixing apparatus of claim 1, wherein the emission controller alters the emission timings in accordance with a color of the recording medium.

10. The flash fixing apparatus of claim 1, wherein an interval between the emission timings is 0.005 seconds.

11. The flash fixing apparatus of claim 1, wherein the emission controller employs a table, which specifies the emission timings in accordance with the physical characteristic of the recording medium, to alter the emission timings.

12. An image formation device comprising a flash fixing apparatus, the flash fixing apparatus comprising:
a plurality of lamp groups each comprising at least one lamp, the each lamp group illuminating a flash at a recording medium to fix a toner image which has been transferred to the recording medium; and
an emission controller that causes the lamp groups to emit light with different emission timings, and that alters the emission timings in accordance with a toner of the toner image and a physical characteristic of the recording medium.

13. The image formation device of claim 12, wherein the emission controller alters voltages supplied to the lamp groups in accordance with the toner of the toner image and a physical characteristic of the recording medium.

14. The image formation device of claim 12, wherein the emission controller alters the emission timings in accordance with a temperature of the recording medium.

15. The image formation device of claim 12, wherein the emission controller alters the emission timings in accordance with a thickness of the recording medium.

16. The image formation device of claim 12, wherein the emission controller alters the emission timings in accordance with a density of the recording medium.

17. The image formation device of claim 12, wherein the emission controller alters the emission timings in accordance with a thermal conductivity of the recording medium.

18. The image formation device of claim 12, wherein the emission controller alters the emission timings in accordance with whether the toner image is a black-and-white image or a color image.

19. The image formation device of claim 12, wherein the emission controller alters the emission timings in accordance with a heat capacity or a color of the recording medium.

20. An image formation method comprising:
flash-fixing a toner image which has been transferred to a recording medium with a plurality of lamp groups,
the plurality of lamp groups each comprising at least one lamp, the each lamp group illuminating a flash at a recording medium to fix; and
controlling a light emission of the lamp groups with different emission timings, and
altering the emission timings in accordance with a toner of the toner image and a physical characteristic of the recording medium.
